(19) United States
(12) Patent Application Publication
(10) Pub. No.: US 2022/0167554 A1
(43) Pub. Date: Jun. 2, 2022

(54) MOWER DECK HILLSIDE ADJUSTMENT SYSTEM

(71) Applicant: Deere & Company, Moline, IL (US)

(72) Inventors: Kelly J. Kowalewski, Nashtoah, WI (US); Kyle T. Ressler, Westbend, WI (US); Meghan M. Krause, Menomonee Falls, WI (US); Benjamin J. Swart, Allenton, WI (US); Joel P. Leyh, Waupun, WI (US); Jorge Cavazos Garcia, Monterrey (MX); Jesse A. Braun, Waukee, IA (US)

(21) Appl. No.: 17/247,084

(22) Filed: Nov. 30, 2020

(51) Int. Cl. A01D 34/86; A01D 34/66; A01D 34/74

(52) U.S. Cl. CPC A01D 34/86; A01D 2101/00; A01D 34/74; A01D 34/66

(57) ABSTRACT

A mower deck hillside adjustment system includes an angle sensor such as an inertial measurement unit mounted to the mower deck for measuring the angle of the mower deck on the roll axis. The angle from the sensor is used to command a left actuator and a right actuator to raise or lower the left side or right side of the mower deck respectively so each side of the mower deck is at the same height to compensate for tire squat and eliminate step cuts.

### FIELD OF THE INVENTION

This invention relates to mower decks suspended from lawn and garden tractors and other grass mowing machines, and more specifically to a mower deck hillside adjustment system to prevent step cuts on hillsides.

### BACKGROUND OF THE INVENTION

A mower deck may be suspended from a lawn and garden tractor, zero turning radius mower or other vehicle, or “floated” on wheels attached to the mower deck. The mower deck may cover one or more rotary cutting blades. When a mower deck is suspended from a vehicle frame, the mower deck and blades should be in proper positioning relative to the mowing vehicle at all cutting heights. For example, the mower deck should be properly aligned so that each rotary cutting blade is level side-to-side, and has a slight forward angle or “rake.” Proper positioning of the mower deck helps achieve better cut quality, prevents grass frazzling, provides better grass dispersal, better bagging results, and reduces the power required to run the engine. Additionally, the mower deck should be calibrated so that the blades are at the cutting height specified by the mower deck height control knob or lever. While conventional mower deck leveling systems are useful on flat or level ground, they are not as effective for keeping the mower deck on the same angle as the actual slope when operating on hillsides.

When mowing across a hillside, a lawn and garden tractor or other mowing vehicle leans downhill due to tire squat. The mower deck, which is mounted to the vehicle frame, follows the frame and also leans downhill. Because the mower deck is not parallel to the ground, the blades cut the grass shorter on the downhill side and longer on the uphill side. This results in a visible cut quality problem often referred to as step cut. A mower deck hillside adjustment system is needed that improves cut quality when mowing on hillsides by eliminating step cutting.

### SUMMARY OF THE INVENTION

A mower deck hillside adjustment system includes an angle sensor that measures the roll angle of a mower deck connected to a mower frame. The system includes a pair of actuators extending between the mower deck frame and the mower deck, and a controller that uses the measured roll angle to command the pair of actuators to adjust each side of the mower deck to the same height. The adjustments compensate for tire squat and eliminate step cuts.

### BRIEF DESCRIPTION OF THE DRAWINGS

FIG. 1 is a top perspective view of a lawn and garden tractor with a mower deck hillside adjustment system according to a first embodiment of the invention.

FIG. 2 is a top perspective view of a mower deck hillside adjustment system according to a first embodiment of the invention.

FIG. 3 is a top perspective view of a mower deck hillside adjustment system according to a second embodiment of the invention.

FIG. 4 is a front view of a lawn and garden tractor on a hillside without activation of the mower deck hillside adjustment system according to a first embodiment of the invention.

FIG. 5 is a front view of a lawn and garden tractor on a hillside with activation of the mower deck hillside adjustment system according to a first embodiment of the invention.

### DESCRIPTION OF THE PREFERRED EMBODIMENT

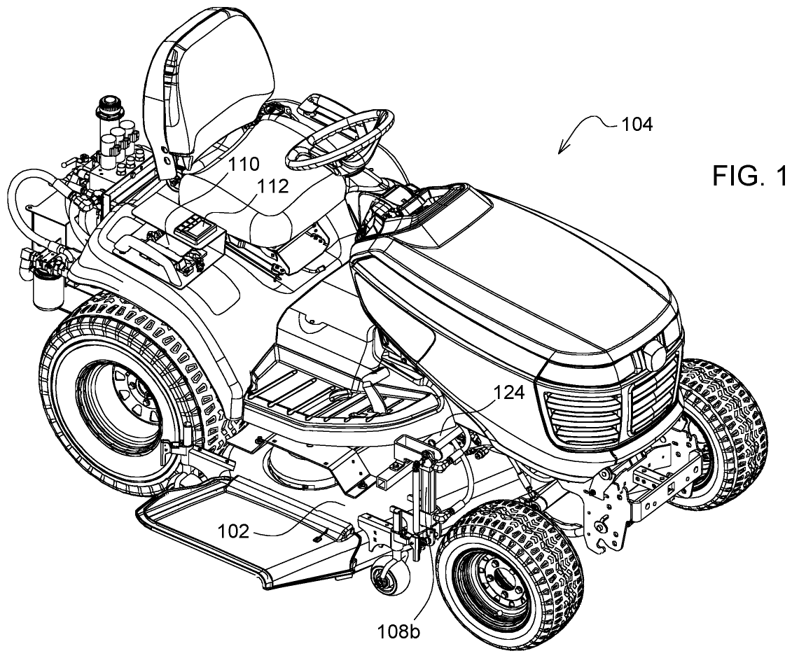

FIG. 1 shows mower deck 102 on lawn and garden tractor 104 between the vehicle's front and rear wheels. The mower deck may cover a plurality of rotary mower blades, each blade mounted to the lower end of a spindle. Pulleys on the upper ends of the spindles may be rotated by one or more endless belts driven by an internal combustion engine or other power source on the lawn tractor, or the blades may be rotated by one or more electric motors.

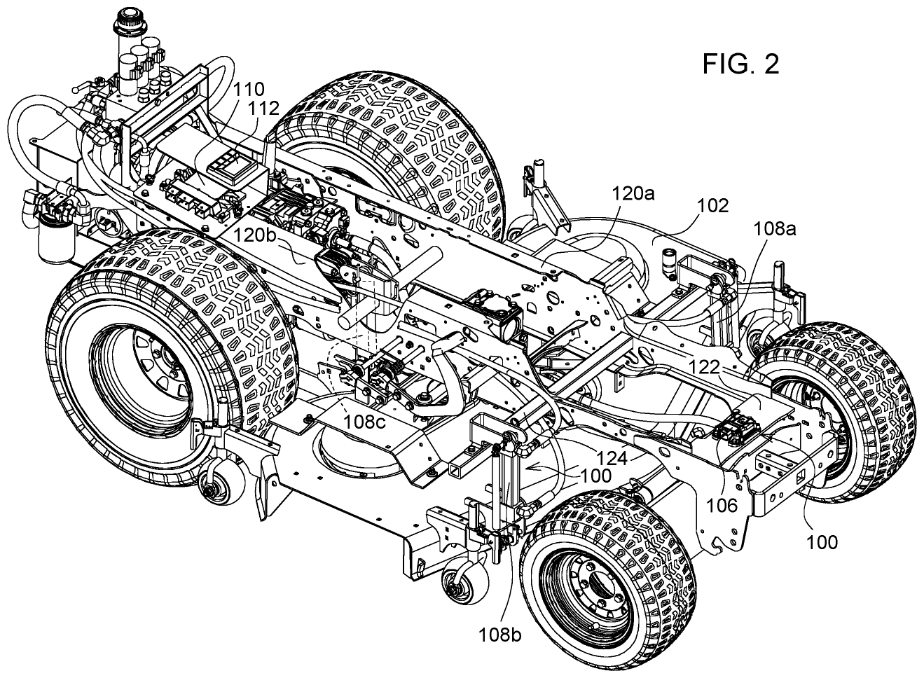

FIG. 2 shows a first embodiment of mower deck hillside adjustment system 100. The system may be on lawn and garden tractor 104 or another vehicle such as a tractor or zero turning radius mower. The vehicle may have a frame with a pair of longitudinal members 120a, 120b connected by one or more cross members 122, 124.

In one embodiment, shown in FIG. 2, mower deck hillside adjustment system 100 may include angle sensor 106 for detecting and measuring the roll angle of the mower deck. The roll angle of the mower deck is the angle of rotation about the vehicle's longitudinal axis in the direction of travel. The roll angle of the mower deck may be zero when the mowing vehicle is on flat level ground, and non-zero when the vehicle is traveling across a hillside and one side of the mower deck is higher off the ground than the other side due to tire squat of the rear tire on the downhill side of the vehicle. The angle sensor may be mounted to the mower deck. Alternatively, the angle sensor may be mounted to the vehicle frame such as cross members 122 or 124 to which the mower deck is attached or suspended, because the roll angle of the vehicle frame and the mower deck may be the same or very nearly the same.

In one embodiment, the preferred angle sensor may be an inertial measurement unit (IMU). The IMU may include one or more accelerometers and/or gyroscopes, and may have a sampling frequency of 3000 Hertz, for example. Alternatively, the angle sensor may be an Inertial Navigation System (INS), Aided INS, tilt sensor, inclinometer, or Attitude Heading Reference System (AHRS). The IMU also may be aided by a Global Position Sensor (GPS). Other alternative angle sensors may be a rotary sensor such as a potentiometer or Hall effect sensor mounted between the frame and front axle of the vehicle.

In one embodiment, the mower deck hillside adjustment system may include a low pass filter that filters the raw roll angle data generated by the angle sensor. The mower deck hillside adjustment system also may compare the absolute value of the filtered roll angle to a constant such as 1000 millidegrees. The absolute value may be compared to the constant because the filtered roll angle may be positive or negative. This may limit the active range of the mower deck hillside adjustment system. The constant also may be adjusted and reset if needed.

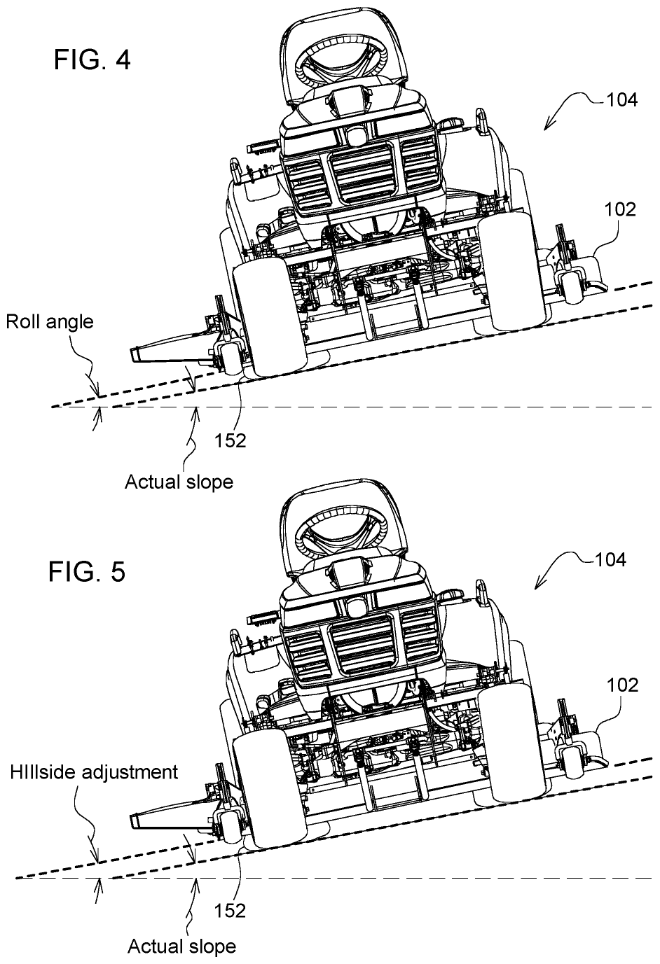

In one embodiment, the mower deck hillside adjustment system may use the filtered roll angle to determine the adjustment for each side of the mower deck. FIG. 4 shows the roll angle of mower deck 102 that is greater than the actual slope of the ground because of tire squat of downhill rear tire 152. The mower deck hillside adjustment system may enter the filtered roll angle in one or more lookup tables, or may use equations to determine the adjustments needed. The controller may use empirical data in the lookup tables or equations from prior testing to determine the adjustments needed so that each side of the mower deck is at the same height from the ground or slope where the mower deck is located. More specifically, the empirical data may show how much of each roll angle is caused by tire squat of the downhill rear tire. FIG. 5 shows the hillside adjustment of mower deck 102 in which each side of the mower deck is adjusted to the same height to compensate for tire squat and eliminate step cuts.

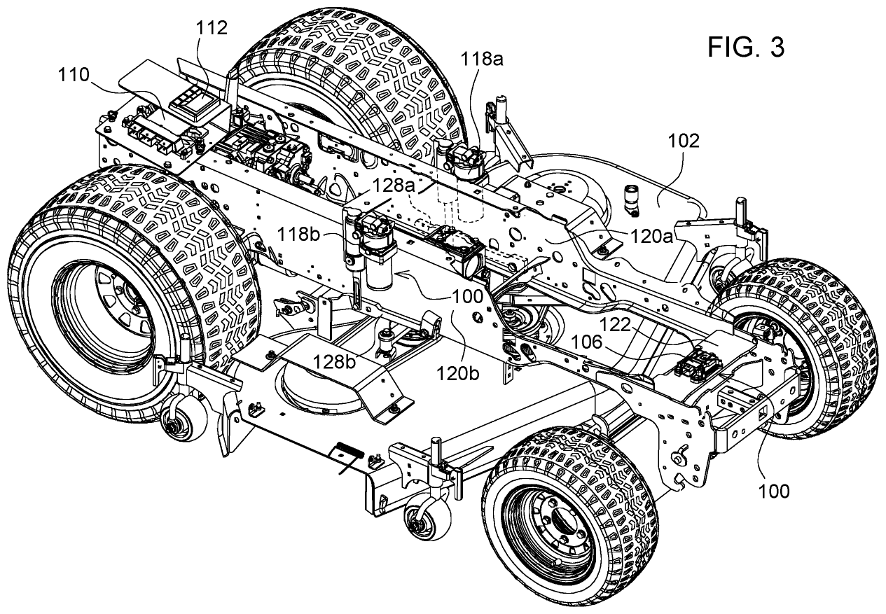

In one embodiment, shown in FIG. 2, the mower deck hillside adjustment system may include at least two actuators to adjust both sides of the mower deck to the same height from the ground or slope. The system includes a left front actuator that raises and lowers the front left side of the deck, and a right front actuator that raises and lowers the front right side of the deck. The pair of actuators also may be used to set height of cut, instead of a single actuator. The pair of actuators may be mounted directly between the vehicle frame and mower deck, or between the frame and an intermediate system such as a rockshaft or pivoting arm that is linked to the mower deck. For example, the pair of actuators may be hydraulic cylinders 108a, 108b with electro-proportional valves. Optionally, the system also may include a third actuator 108c which also may be a hydraulic cylinder to adjust the rear of the deck. Controller 110 may command each of the pair of actuators to extend or retract to move each side of the mower deck to an adjusted height based on the calculated hillside adjustment. Linear sensors may be used for cylinder position feedback. In another embodiment, shown in FIG. 3, the system may include two electric actuators 118a, 118b connected to linkages 128a, 128b that are part of a parallelogram linkage to set the height of cut and adjust each side of the mower deck.

In one embodiment, mower deck hillside adjustment system 100 may include calculating the hillside adjustment for each actuator based on the detected roll angle. Optionally, the height of cut setting also may be used as an input to calculate the hillside adjustment for each actuator. The height of cut may be set using electronic display unit 112 and/or keypad 114 by the operator and provided electronically to the controller. For example, the height of cut setting may impact the hillside adjustment for each actuator if the height of cut setting is at or near upper or lower limits, or depending on the rigidity of the mower deck lift mechanism.

In one embodiment, shown in FIG. 2, mower deck hillside adjustment system may include controller 110 which may calculate and output a hillside adjustment for each actuator. For example, the controller may multiply the slope and an inverted slope constant, multiply roll and slope, and divide the product of roll and slope by constants or unit regularizing values. The controller then may add each actuator's hillside adjustment to the height of cut setting, and output the resulting height to the actuator if the system is active. The system may be active only if roll angle is as high as the constant described above, or within a specified range of detected roll angles. The controller may output the original height of cut setting to the actuator if the system is inactive. Additionally, the mower deck hillside adjustment system may include mower deck display 112 and keypad 114 which the operator may use to set the height of cut, change the constant, and other settings.

Having described the preferred embodiment, it will become apparent that various modifications can be made without departing from the scope of the invention as defined in the accompanying claims.

1. A mower deck hillside adjustment system, comprising:
an angle sensor that measures a roll angle of a mower deck connected to a mower frame;
a pair of actuators extending between the mower frame and a first side and a second side of the mower deck; and
a controller using the measured roll angle to command the pair of actuators to adjust a height of the first side and the second side of the mower deck.

2. The mower deck hillside adjustment system of claim 1 wherein one of the pair of actuators extends between a left side of the mower deck and the mower frame, and the other of the pair of actuators extends between a right side of the mower deck and the mower frame.

3. The mower deck hillside adjustment system of claim 1 wherein the pair of actuators are hydraulic cylinders with electro-proportional valves.

4. The mower deck hillside adjustment system of claim 1 wherein the pair of actuators are electric actuators.

5. The mower deck hillside adjustment system of claim 1 wherein the angle sensor is an inertial measurement unit.

6. A mower deck hillside adjustment system, comprising:
an inertial measurement unit mounted to a mower deck for measuring an angle of the mower deck relative to a roll axis; and
a controller that uses the angle from the inertial measurement unit to command a left actuator and a right actuator to raise or lower a left side of the mower deck and a right side of the mower deck respectively so each side of the mower deck is at a same height from a slope where the mower deck is located.

7. The mower deck hillside adjustment system of claim 6 wherein the controller also uses a height of cut setting to adjust the mower deck to the slope.

8. The mower deck hillside adjustment system of claim 6 further comprising a rear actuator commanded by the controller to raise or lower a rear of the mower deck.

9. The mower deck hillside adjustment system of claim 1 wherein the controller uses a look up table to determine the adjustment of each actuator.

10. A method for mower deck hillside adjustment, comprising the steps of:
detecting and measuring a roll angle of a mower deck;
and
using a pair of actuators, on a left side and a right side of the mower deck, to adjust the roll angle of the mower deck so that the left side and the right side of the mower deck are at a same height from a ground surface.

11. The method for mower deck hillside adjustment of claim 10 further comprising a step of using a lookup table to determine the adjustment based on the roll angle due to tire squat of a downhill tire.

12. The method for mower deck hillside adjustment of claim 10 further comprising a step of using a height of cut setting to adjust the roll angle of the mower deck.
